(19) United States
(12) Patent Application Publication
(10) Pub. No.: US 2025/0358869 A1
(43) Pub. Date: Nov. 20, 2025

(54) SELECTING SUBSETS OF WIRELESS DEVICES

(71) Applicant: LENOVO (SINGAPORE) PTE. LT, SINGAPORE (SG)

(72) Inventors: Hyung-Nam Choi, Ottobrunn (DE); Karthikeyan Ganesan, Kronberg Im Taunus (DE); Ali Ramadan Ali, Kraiburg (DE); Abdul Rasheed Mohammed, Hyderabad (IN); Genadi Velev, Darmstadt (DE)

(73) Assignee: LENOVO (SINGAPORE) PTE. LT, SINGAPORE (SG)

(21) Appl. No.: 18/664,252

(22) Filed: May 14, 2024

(51) Int. Cl. H04W 74/0833; H04W 74/00

(52) U.S. Cl. CPC H04W 74/085; H04W 74/004

(57) ABSTRACT

Various aspects of the present disclosure relate to selecting subsets of wireless devices. Subsets of wireless devices from a larger set of wireless devices are selected. A reader device performs a task (e.g., inventory taking, write command) serially with the subsets, e.g., first with the target wireless devices of a first subset, then afterwards with the target wireless devices of a second subset, and so forth. Various different information or data describing the wireless devices (e.g., characteristics of the wireless devices) can be stored in the wireless devices (e.g., in non-volatile memory) that allow subsets of wireless devices to be selected. Subsets of wireless devices can be selected based on any one or more of this information or data.

### TECHNICAL FIELD

The present disclosure relates to wireless communications, and more specifically to selecting subsets of wireless devices.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a first device for wireless communication. The first device receives a first message that indicates to initiate a procedure for a set of second wireless devices, wherein the first message includes a set of one or more of multiple types of information associated with the set of second wireless devices; transmits a second message that indicates to initiate the procedure for a subset of second wireless devices based at least in part on the set of one or more of multiple types of information, wherein the subset of second wireless devices is a subset of the set of second wireless devices; receives a third message from at least one second wireless device of the subset of second wireless devices in response to the second message.

In some implementations of the method and apparatuses described herein, the first device receives the first message from a network entity associated with a core network. Additionally or alternatively, for each wireless device of the set of second wireless devices, the set of one or more of multiple types of information include one or more of a device identifier (ID) of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value. Additionally or alternatively, the procedure comprises an inventory or command procedure. Additionally or alternatively, each wireless device of the set of second wireless devices comprises a low-complexity and low-power device. Additionally or alternatively, the first wireless device comprises a network node or an intermediate node.

Some implementations of the method and apparatuses described herein may further include a processor for wireless communication. The processor receives a first message that indicates to initiate a procedure for a set of second wireless devices, wherein the first message includes a set of one or more of multiple types of information associated with the set of second wireless devices; transmits a second message that indicates to initiate the procedure for a subset of second wireless devices based at least in part on the set of one or more of multiple types of information, wherein the subset of second wireless devices is a subset of the set of second wireless devices; receives a third message from at least one wireless device of the subset of second wireless devices in response to the second message.

In some implementations of the method and apparatuses described herein, the processor receives the first message from a network entity associated with a core network. Additionally or alternatively, for each wireless device of the set of second wireless devices, the set of one or more of multiple types of information include one or more of a device ID of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value. Additionally or alternatively, the procedure comprises an inventory or command procedure. Additionally or alternatively, each wireless device of the set of second wireless devices comprises a low-complexity and low-power device. Additionally or alternatively, the processor is included in a network node or an intermediate node.

Some implementations of the method and apparatuses described herein may further include a first device for wireless communication. The first device receives a first message that indicates to initiate a procedure for a subset of wireless devices based at least in part on a set of one or more of multiple types of information stored in a set of wireless devices, wherein the subset of wireless devices is a subset of the set of wireless devices, and wherein the first wireless device is part of the set of wireless devices; transmits a second message, in response to the first message, if the first wireless device satisfies the set of one or more of multiple types of information.

In some implementations of the method and apparatuses described herein, the set of one or more of multiple types of information stored in the first wireless device include one or more of a device ID of the first wireless device, a device type of the first wireless device, a memory storage capability of the first wireless device, a security capability of the first wireless device, a positioning capability of the first wireless device, a network ID of a network operator of the first wireless device, a manufacturer ID of the first wireless device, a service ID of one or more services the first wireless device is subscribed to, or a random value. Additionally or alternatively, the set of one or more of multiple types of information are stored in non-volatile memory of the first wireless device. Additionally or alternatively, the procedure comprises an inventory or command procedure. Additionally or alternatively, the first wireless devices comprises a low-complexity and low-power device.

Some implementations of the method and apparatuses described herein may further include a method performed by a first wireless device, the method comprising: receiving a first message that indicates to initiate a procedure for a set of second wireless devices, wherein the first message includes a set of one or more of multiple types of information associated with the set of second wireless devices; transmitting a second message that indicates to initiate the procedure for a subset of second wireless devices based at least in part on the set of one or more of multiple types of information, wherein the subset of second wireless devices is a subset of the set of second wireless devices; and receiving a third message from at least one second wireless device of the subset of second wireless devices in response to the second message.

In some implementations of the method and apparatuses described herein, the method further comprises receiving the first message comprises receiving the first message from a network entity associated with a core network. Additionally or alternatively, in some implementations of the method and apparatuses described herein, the method further comprises: for each wireless device of the set of second wireless devices, the set of one or more of multiple types of information include one or more of a device ID of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value.

### BRIEF DESCRIPTION OF THE DRAWINGS

FIG. 1 illustrates an example of a wireless communications system in accordance with aspects of the present disclosure.

FIG. 2 illustrates an example of a scenario for selecting devices in accordance with aspects of the present disclosure.

FIGS. 3 and 4 illustrate example deployment scenarios in accordance with aspects of the present disclosure.

FIG. 5 illustrates an example block diagram in accordance with aspects of the present disclosure.

FIG. 6 illustrates an example Ambient Internet of Things (AIoT) device in accordance with aspects of the present disclosure.

FIGS. 7 through 10 illustrate example signaling diagrams in accordance with aspects of the present disclosure.

FIG. 11 illustrates an example of a device in accordance with aspects of the present disclosure.

FIG. 12 illustrates an example of a processor in accordance with aspects of the present disclosure.

FIG. 13 illustrates an example of a network equipment (NE) in accordance with aspects of the present disclosure.

FIGS. 14 and 15 illustrate flowcharts of methods in accordance with aspects of the present disclosure.

### DETAILED DESCRIPTION

AIoT refers to a technology that may be deployed in a wireless communications system (e.g., in a 3GPP system). An AIOT device refers to a low-complexity device with low power consumption for low-end Internet of Things (IoT) applications, such as inventory management (e.g., monitoring, tracking), sensor data management (e.g., collecting, tracking, controlling), and so forth. For instance, indoor inventory and indoor command are example use cases for AIoT. Indoor inventory refers to the inventory-taking of one or more AIoT devices that are located indoors. Similarly, indoor command refers to read, write, control, enable, disable, and so forth for one or more AIoT devices that are located indoors. An indoor location may be, for example, a warehouse, a factory, a mall, an airport terminal, a home, and so forth.

A wireless communications system, including a reader device may desire (e.g., for efficiency reasons) to support the same operation (e.g., action, task) concurrently for multiple target AIOT devices that are located in a target area. For example, the reader device may want to take inventory in a short amount of time of all AIoT devices that are located in the target area. Another example is when the reader device wants to write in a short amount of time the same data (e.g., a new password for privacy-sensitive applications) into the memory of all AIoT devices that are located in the target area. However, considering the fact that many target AIoT devices may be located in the target area (e.g., up to 150 devices per 100 square meters (m²)), the number of target AIoT devices to select for the operation is to be carefully chosen in order to balance the load for a random access procedure that will take place between the target AIoT devices and the reader device. If the number of selected target AIoT devices is too high (e.g., equal to or greater than a threshold value) then it may result in a high collision probability of the random access and thus additional latency for resolving the collisions.

The techniques discussed herein efficiently select subsets (also referred to as subpopulations) of AIoT devices from a larger set (also referred to as a larger population) of AIoT devices. A reader device (e.g., a base station or an intermediate node) performs the task (e.g., inventory taking, write command) serially with the subsets, e.g., first with the target AIoT devices of a first subset, then afterwards with the target AIoT devices of a second subset, and so forth.

Various different information or data describing the AIoT devices (e.g., characteristics of the AIoT devices) can be stored in the AIoT devices (e.g., in non-volatile memory) that allow subsets of AIoT devices to be selected. This information or data can be, for example, a device identifier of the AIoT device, a device type of the AIoT device, memory storage capabilities of the AIoT device, positioning capabilities of the AIoT device, and so forth. Subsets of AIoT devices can be selected based on any one or more of this information or data. For example, subsets of AIoT devices can be selected based on device types, memory storage capabilities, positioning capabilities, and so forth.

Accordingly, the techniques discussed herein provide a great deal of flexibility in how a wireless communications system selects subsets of AIoT devices. In contrast to a solution that relies solely on selecting subsets based on one or more filter masks that are applied to a device identifier (e.g., a radio frequency identification (RFID) transponder identifier or an electronic product code (EPC)), the techniques discussed herein allow the subsets of AIoT devices to be selected based at least in part on one or more of a variety of different characteristics of the AIoT devices.

Reference is made herein to receiving or transmitting data, information, messages, and so forth. It is to be appreciated that other terms may be used interchangeably with receiving or transmitting, such as communicating, outputting, forwarding, retrieving, obtaining, and so forth.

Aspects of the present disclosure are described in the context of a wireless communications system.

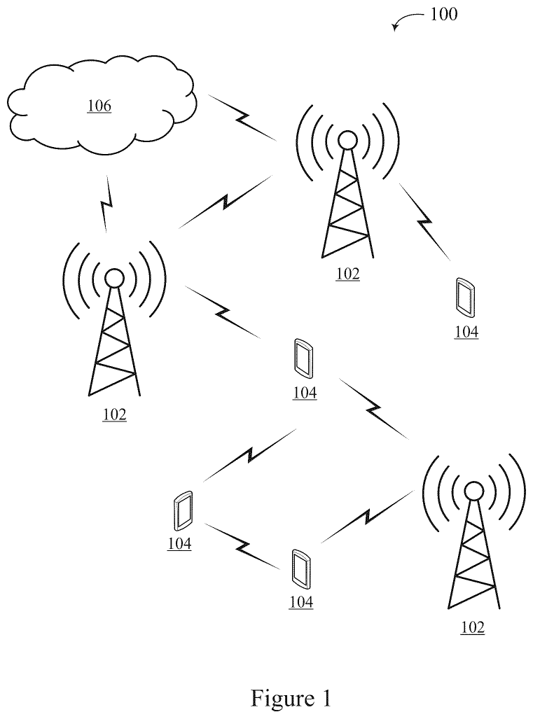

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (CNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, an NE 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the NEs 102 may be located in distributed locations (e.g., separate physical locations). In some implementations, one or more NEs 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective NEs 102 that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologics (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHZ-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 can include any number of AIoT devices. AIoT devices include devices that consume very low power and/or rely on harvesting energy. One example of such a device is a device (e.g., referred to as a passive device) that has no energy storage, no independent signal generation, and uses backscattering transmission. Another example of such a device is a device (e.g., referred to as a semi-passive device) that has energy storage, no independent signal generation, and uses backscattering transmission. Use of stored energy can include amplification for reflected signals. Another example of such a device is a device (e.g., referred to as an active device) that has energy storage, has independent signal generation (e.g., an active RF component for transmission), and may use backscattering transmission. AIoT devices also typically do not include a subscriber identity module (SIM) card.

The AIoT device may be classified or defined as a low-power device if a power consumption level of the AIoT device satisfies (e.g., is less than) a threshold value. The AIoT device may include a low-power processor to reduce the power consumption level of the AIoT device. A low-power processor may be a processor that operates with a power consumption level that satisfies (e.g., is less than) a threshold value. A low-power device may have reduced functionality when compared with a wireless device that operates at a power consumption level that is greater than the threshold values.

The AIoT device may be classified or defined as a low-complexity device if the hardware components or capabilities of the AIoT device are less than a threshold amount or less than a threshold capability. A low-complexity device may have reduced functionality when compared with a wireless device that includes hardware components or capabilities that are greater than the threshold values. For example, a low-complexity device may have reduced processing capabilities for decoding and generating signaling, may have reduced transmission and/or reception capabilities (e.g., transmission and/or reception range, protocol stack, among others), reduced energy storage capabilities (e.g., smaller battery), or the like when compared with other wireless devices that are not low-complexity or low-power.

In one or more implementations, the AIoT device may be a sensor (e.g., a tag), an actuator, an appliance, or another device capable of connecting to a wireless network. In some examples, the AIoT device is categorized according to a set of components and/or capabilities of the AIoT devices, where the categories include one or more of an active AIoT device category, a semi-passive AIoT device category, and/or a passive AIoT device category. An active AIoT device includes a power source and an active radio frequency component, such as a transmitter and/or receiver component, for signal generation. The transmitter and/or receiver component may include one or more antennas for transmitting and receiving signaling. A semi-passive AIoT device may have energy storage capabilities but may not include an active radio frequency component for signal generation. A passive AIoT device may not have energy storage capabilities or an active radio frequency component.

In some cases, semi-passive AIoT devices and passive AIoT devices use backscattering techniques and/or energy harvesting for transmitting and/or receiving signaling. In variations, an active AIoT device may use a transmitter and/or receiver component for transmitting or receiving signaling and/or may use backscattering techniques for transmitting and/or receiving signaling. Semi-passive AIoT devices may use the stored energy to amplify a signal when using backscattering techniques. Backscattering techniques include receiving signaling from a source device (e.g., a node such as an intermediate node) and modulating a reflection of the incoming signaling towards a destination device (e.g., a reader node such as an intermediate node). Thus, the AIoT device may not use an active receiver and/or transmitter component for receiving and transmitting signaling, which reduces a power consumption level of the device.

In some examples, the AIoT device may be capable of energy harvesting using energy harvesting techniques. For example, the AIoT device may extract energy from transmission waves from a source device (e.g., an NE) to power the AIoT device. The source device may transmit the signaling using a continuous wave waveform in which the signaling has a constant amplitude and frequency and/or a carrier wave waveform in which the signaling has a periodic variation in amplitude, duration, and position. Signaling transmitted using a continuous wave waveform may be referred to as a continuous wave transmission, while signaling transmitted using a carrier wave waveform may be referred to as a carrier wave transmission. If the AIoT device includes an energy storage component, then the AIoT device may store the extracted energy for later use (e.g., to amplify a reflection of signal or to generate a new signal).

AIOT refers to a technology suitable for deployment in a wireless communications system (e.g., a 3GPP system), and an AIoT is a low-complexity device with low power consumption for low-end IoT applications, e.g., inventory taking, sensor data collection, tracking and actuator control, and so forth.

Table 1 describes various aspects of AIoT that may be implemented in a wireless communications system.

TABLE 1

| Design | Target | Note |
|---|---|---|
| Device types | Type 1: approximately 1 microwatt | Transmission from AIoT |
| | (μW) peak power consumption, has | device (including |
| | energy storage, initial sampling | backscattering when used) |
| | frequency offset (SFO) up to 10^{X} | can occur at least in UL |
| | parts per million (ppm), neither | spectrum. |
| | downlink (DL) nor uplink (UL) | Type 1 and Type 2a devices |
| | amplification in the device. The | are passive devices, |
| | device's UL transmission is | whereas Type 2b devices |
| | backscattered on a carrier wave | are active devices. |
| | provided externally. | |
| | Type 2a: less than or equal to a few | |
| | hundred μW peak power | |
| | consumption, has energy storage, | |
| | initial SFO up to 10^{X} ppm, DL and/or | |
| | UL amplification in the device. The | |
| | device's UL transmission is | |
| | backscattered on a carrier wave | |
| | provided externally. | |
| | Type 2b: less than or equal to a few | |
| | hundred μW peak power | |
| | consumption, has energy storage, | |
| | initial SFO up to 10^{X} ppm, DL and/or | |
| | UL amplification in the device. The | |
| | device's UL transmission is generated | |
| | internally by the device. | |
| Coverage | Max distance of 10-50 meters (m) with | |
| | device indoors | |
| Deployment | Deployment scenario 1 with | Deployment scenario 1: |
| scenarios | Topology 1 | Base station (micro-cell, |
| | Deployment scenario 2 with | co-site) and AIoT |
| | Topology 2 and UE as intermediate | device are indoors. |
| | node, under network control | Deployment scenario 2: |
| | | Base station (macro- |
| | | cell, co-site) is outdoors |
| | | and intermediate |
| | | UE/AIOT device are |
| | | indoors. |
| Spectrum | FR1 licensed spectrum in frequency | FR1 refers to the frequency |
| | division duplex (FDD) | range of 410 megahertz |
| | | (MHz)-7125 MHz. |
| Spectrum | In-band to NR | |
| deployment | In guard-band to LTE/NR | |
| | In one or more standalone bands | |
| Traffic | Device-originated - device- | Focus is on rUC1 (indoor |
| types | terminated triggered (DO-DTT) | inventory) and rUC4 |
| | Device-terminated (DT) | (indoor command). |
| Protocol | No radio resource control (RRC) | |
| aspects | states | |
| and | No mobility (e.g., at least no cell | |
| mobility | selection or re-selection-like function) | |
| | No hybrid automatic repeat request | |
| | (HARQ) | |
| | No automatic repeat request (ARQ) | |

Indoor inventory and indoor command are example use cases for AIoT. Indoor inventory refers to the inventory-taking of one or more AIOT devices that are located indoors. Similarly, indoor command refers to read, write, control, enable, disable, and so forth one or multiple AIoT devices that are located indoors. An indoor location may be, for example, a warehouse, a factory, a mall, an airport terminal, a home, and so forth.

For efficiency reasons, the network may want to perform the same task concurrently for multiple target AIOT devices that are located in a target area. For instance, the network may want to take inventory in short time of all AIoT devices that are located in a target area. Another example is when the network wants to write in short time the same data (e.g., a new password for privacy-sensitive applications) into the memory of all AIoT devices that are located in a target area. However, considering the fact that many target AIoT devices may be located in a target area, e.g., up to 150 devices per 100 m2, the number of target AIoT devices to select for the task is to be carefully chosen in order to balance the load in the random access procedure that will take place between the target AIoT devices and the reader. If the number of selected target AIoT devices is too high then it may result in high collision probability of the random access and thus additional latency for resolving the collisions.

Therefore, the techniques discussed herein efficiently select subsets (also referred to as subpopulations) of AIoT devices from a larger set (also referred to as a larger population) of AIoT devices. A subset of a set as discussed herein may be a proper subset (e.g., all of the elements of the subset are included in the set, but not all of the elements of the set are included in the subset).

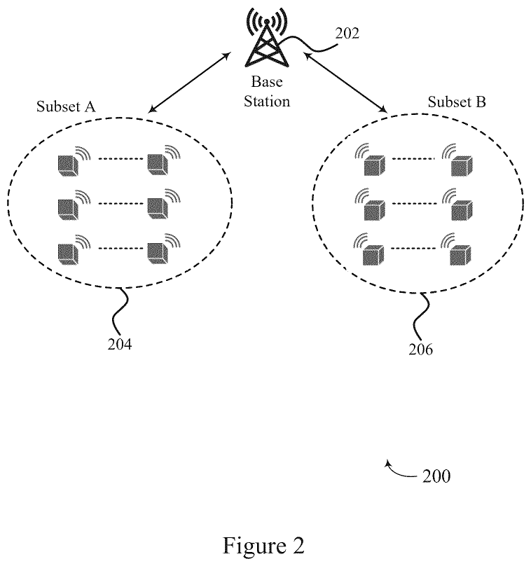

FIG. 2 illustrates an example 200 of a scenario for selecting devices in accordance with aspects of the present disclosure. The example 200 shows an exemplary scenario for selecting target AIoT devices where the target AIoT devices have been separated into two subsets A and B. A base station 202 acting as a reader performs a task (e.g., inventory-taking, write-command) first with a subset of target AIoT devices 204 (illustrated as subset A), then afterwards with a subset of target AIoT devices 206 (illustrated as subset B).

With regards to selecting one or more subsets of target AIoT devices (e.g., the subset of target AIoT devices 204 or the subset of target AIoT devices 206), a solution is where the base station 202 (e.g., the reader) indicates to the selected subset of target AIoT devices a filter mask in the select command that is applied to the information stored in the memory of the selected subset of target AIoT devices. For instance, the filter mask indicates for which type of information (e.g., unique AIoT device ID, EPC) the mask shall be applied, the starting bit for the mask comparison, the length of the mask and the mask value. All selected subset of target AIoT devices receiving the select command from the base station 202 (e.g., the reader) determine whether the information stored in the memory of each of the selected subset of target AIoT devices matches with the indicated filter mask. The selected subset of target AIoT devices identify as being selected for the following inventory or command procedure based on the match. All non-selected subset of target AIoT devices (e.g., the subset of target AIoT devices 204 or the subset of target AIoT devices 206) (also referred to as non-matching AIoT devices) do not take part in the following inventory or command procedure. Instead, the non-selected subset of target AIoT devices monitor for a new select command from the base station 202 (e.g., the reader). However, this solution is not flexible enough considering the design targets of AIoT and the network involvement. Accordingly, the techniques discussed herein provide a more flexible solution for selecting subsets of AIoT devices from a larger set.

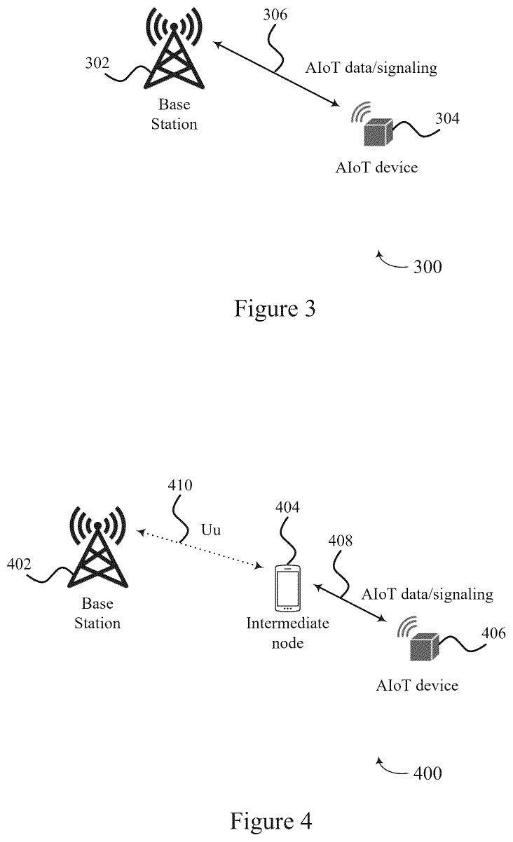

FIG. 3 illustrates an example deployment scenario 300 in accordance with aspects of the present disclosure. The deployment scenario 300 may also be referred to as deployment scenario 1 with a first topology (e.g., Topology 1) for consideration with AIoT. The deployment scenario 300 illustrates a base station 302 and an AIoT device 304. The AIoT device 304 directly and bidirectionally may communicate (e.g., transmit to, receive from) with the base station 302. The base station 302 may have a coverage area, which may be a micro cell. The communication between the base station 302 and the AIoT device 304 may include AIoT data and/or signaling 306. In deployment scenario 300, the base station 302 and the AIoT device 304 may be indoors (e.g., location, environment). The base station 302 may be co-sited (e.g., collocated) with another base station supporting other radio access technologies (e.g., 4G LTE and/or 5G NR).

FIG. 4 illustrates an example deployment scenario 400 in accordance with aspects of the present disclosure. The deployment scenario 400 may also be referred to as deployment scenario 2 with a second topology (e.g., Topology 2) for consideration with AIoT. The deployment scenario 400 illustrates a base station 402, an intermediate node 404, and an AIoT device 406. The AIoT device 406 communicates (e.g., receives, transmits) bidirectionally with the intermediate node 404 (e.g., a UE as described with reference to FIG. 1), between the AIoT device 406 and the base station 402. The base station 402 may have a coverage area, which may be a macro cell. The intermediate node 404 may be capable of, configured to, or operable to AIoT. The intermediate node 404 communicates AIoT data and/or signaling 408 between the base station 402 and the AIoT device 406, communicating (e.g., transmitting, receiving) with the base station 402 via an interface 410 (e.g., a Uu interface). In deployment scenario 400, the base station 402 may be outdoors (e.g., at a first location or within a first environment) whereas the intermediate node 404 and the AIoT device 406 may be indoors (e.g., at a second location or a second environment different than the first location or the first environment). The base station 402 may be co-sited (e.g., collocated) with another base station supporting other radio access technologies (e.g., 4G LTE and/or 5G NR).

AIoT devices may be low-complexity devices with low power consumption for low-end IoT applications. Accordingly, a radio protocol stack architecture for AIoT devices may be expected to be compact compared to the radio protocol stack architecture as specified for NR.

FIG. 5 illustrates a block diagram 500 of an AIoT device 502 and a node 504 in accordance with aspects of the present disclosure.

The node 504 may be a network entity, a base station, or an intermediate node (e.g., a UE or the device) as described herein. The AIoT device 502 may be equipped (e.g., configured) with at least one protocol stack associated with a control plane (also referred to as an AIoT control plane). For example, the at least one protocol stack of the AIoT device 502 may support one or more of receiving, obtaining, transmitting, or outputting one or more of control information (e.g., AIoT control information, such as commands). The at least one protocol stack of the AIoT device 502 may include one or more protocol layers, which may be ordered in a hierarchical architecture, including an RRC layer 506 (or an RRC sublayer), a data link control (DLC) layer 510 (or a DLC sublayer), and a PHY layer 514 (or a PHY sublayer). Additionally, the node 504 may be equipped (e.g., configured) with at least one protocol stack associated with a control plane. For example, the at least one protocol stack of the node 504 may support one or more of receiving, obtaining, transmitting, or outputting one or more of control information (e.g., AIoT control information, such as commands). The at least one protocol stack of the node 504 may include one or more protocol layers, which may be ordered in a hierarchical architecture, including an RRC layer 508 (or an RRC sublayer), a DLC layer 512 (or a DLC sublayer), and a PHY layer 516 (or a PHY sublayer).

The functions of the RRC layers 506, 508 (RRC sublayers) include transfer of system information, paging, transfer of upper layer PDUs, activation of access stratum (AS) security. The functions of the DLC layer 510, 512 (DLC sublayers) include transfer of data (user plane (U-plane) or C-plane), ciphering, integrity protection, multiplexing of DLC service data units (SDUs) into transport blocks (TB) delivered to PHY. The functions of the PHY layers 514, 516 (PHY sublayers) include channel coding, error detection, modulation, frequency and time synchronization, measurements. The term “SDU” may refer to a data unit that is received (e.g., obtained) or transmitted (e.g., outputted, forwarded) by a sublayer from or to a higher sublayer of a protocol stack. Likewise, the term “PDU” may refer to a data unit that is transmitted (e.g., outputted, forwarded) or received (e.g., obtained) by a sublayer to or from a lower sublayer.

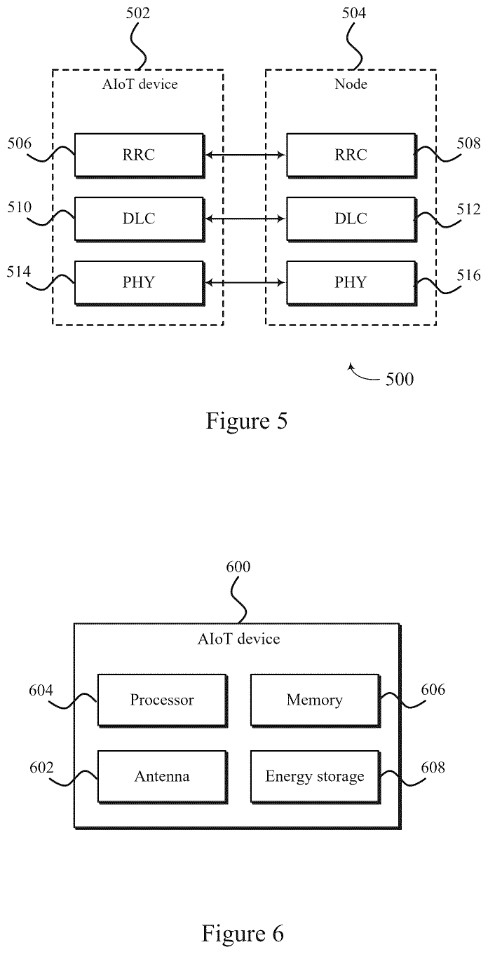

FIG. 6 illustrates an example AIoT device 600 in accordance with aspects of the present disclosure. The AIoT device 600 includes a simplified AIoT device architecture, such as the architecture for a low-complexity and low-power device.

The AIoT device 600 includes an antenna 602, a processor 604, a memory 606, and an energy storage 608.

The antenna 602 is used to transmit or receive RF signals to or from the reader (e.g., the base station 302 of FIG. 3 or the intermediate node 404 of FIG. 4). Furthermore, in case of a passive AIoT device, the antenna 602 is used to receive an unmodulated carrier wave from the reader and/or an external carrier wave node. This carrier wave is used for transmitting RF signals to the reader based on backscattering. In addition, the antenna 602 is used for harvesting energy from the radio waves received from the reader and/or an external carrier wave node.

The processor 604 is used to perform all the processing that is needed for the communication between the AIoT device 600 and the reader (e.g., the base station 302 of FIG. 3 or the intermediate node 404 of FIG. 4), such as modulation/demodulation and encoding/decoding of the information that is transmitted or received, writing or reading information to or from the memory, and so forth.

The memory 606 is used to store information for the operation of the AIoT device 600. The memory size may vary, e.g., in the range from 1 kiloByte (kByte) to 8 kiloBytes (kBytes), and may depend on the applications that the AIoT device 600 supports. In addition, the memory of the AIoT device 600 may include two types of memory, non-volatile memory (NVM) and/or volatile memory (VM). NVM refers to memory for permanently storing information. Any information stored in NVM will not get lost even if there is no energy available in the AIoT device 600. VM refers to memory for temporarily storing information that is used operation of the AIoT device 600 only while energy is available in the AIoT device 600.

The energy storage 608 is used to store and supply energy to the AIoT device 600. In case of a passive AIoT device the energy is harvested from the radio waves received from the reader (e.g., the base station 302 of FIG. 3 or the intermediate node 404 of FIG. 4) and/or an external carrier wave node, or any other suitable energy source (e.g., light, motion, heat) and is stored in a capacitor. In case of an active AIoT device the energy comes from a battery.

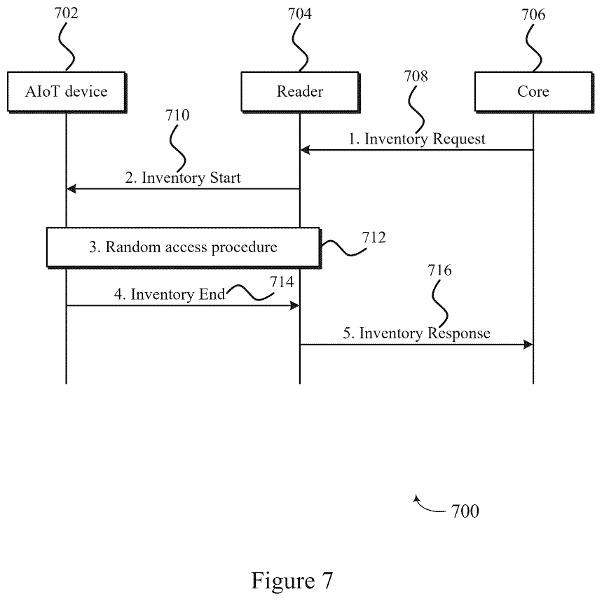

FIG. 7 illustrates an example signaling diagram 700 in accordance with aspects of the present disclosure. The signaling diagram 700 may include an AIoT device 702, a reader 704, and a core 706 (e.g., a component of a CN 106 of FIG. 1, such as a 5G core (5GC)). In the example of FIG. 7, the signaling diagram 700 may be for an inventory procedure that can be applied for both indoor and outdoor scenarios. For the signaling diagram 700, it is assumed that an application client wants to retrieve an identity of an object (e.g., a product or good), that is located in an area of a warehouse. The identity of the object (e.g., EPC) is stored in the memory of the AIoT device 702 (also referred to as a target AIoT device) that is attached to the object. The application client may reside in a network or a third party entity attached to the network. The reader 704 may be a base station or an intermediate node (e.g., a UE).

The application client (not shown in FIG. 7) may transmit a request to the core 706 to retrieve an EPC of an object that is located in a target area and to which the AIoT device 702 is attached. The request may include information about the target area and the AIoT device 702 (e.g., a unique device ID). Based on the received request from the application client, at 708 (Step 1), the core 706 (e.g., an AMF or an AIoT function) may transmit an inventory request message to the reader 704 that serves the target area. The inventory request message may include the unique device ID of the AIoT device 702. At 710 (Step 2), the reader 704 may transmit an inventory start message to retrieve the EPC from the AIoT device 702. The inventory start message may include the unique device ID of the AIoT device 702.

At 712 (Step 3), in response to (e.g., based on) receiving the inventory start message, the AIoT device 702 may perform a random access procedure with the reader 704 in order to ensure that the EPC can be provided (e.g., transmitted) successfully to the reader 704. At 714 (Step 4), in response to (e.g., based on) a successful completion of the random access procedure, the AIoT device 702 may transmit to the reader 704 the inventory end message including the EPC (e.g., the stored EPC at the AIoT device 702). At 716 (Step 5), the reader 704 may transmit to the core 706 the inventory response message that contains the EPC received from the AIoT device 702. The core 706 may then forward the received EPC to the application client.

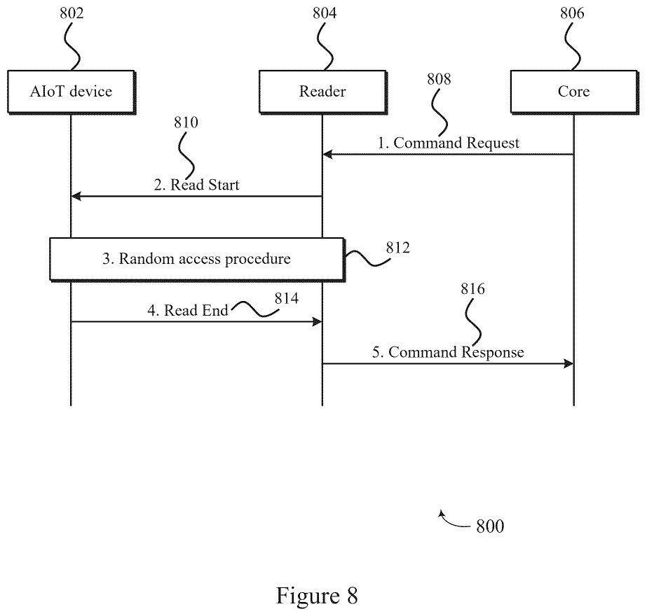

FIG. 8 illustrates an example signaling diagram 800 in accordance with aspects of the present disclosure. The signaling diagram 800 may include an AIoT device 802, a reader 804, and a core 806 (e.g., a component of a CN 106 of FIG. 1, such as a 5GC). In the example of FIG. 8, the signaling diagram 800 may be for a command procedure which can be applied for both indoor and outdoor scenarios. For the signaling diagram 800, it is assumed that an application client wants to retrieve data (other than EPC) of an object that is located in an area of a warehouse. The data are stored in the memory of the AIoT device 802 (also referred to as a target AIoT device) that is attached to the object. The application client may reside in a network or a third party entity attached to the network. The reader 804 may be a base station or an intermediate node (e.g., a UE).

The application client (not shown in FIG. 8) may transmit a request to the core 806 to retrieve data of an object that is located in a target area and to which the AIoT device 802 is attached. The request may include information about the target area, the AIoT device 802 and a type of the requested data. Based on the received request from the application client, at 808 (Step 1), the core 806 (e.g., an AMF or an AIoT function) may transmit a command request message to the reader 804 that serves the target area. The command request message may include information about the AIoT device (e.g., a unique device ID) and the type of requested data. At 810 (Step 2), the reader 804 may transmit a read start message to retrieve the requested type of data from the AIoT device 802. The read start message may contain the unique device ID of the AIoT device 802 and the requested type of data.

At step 812 (Step 3), in response to (e.g., based on) receiving the read start message, the AIoT device 802 may perform a random access procedure with the reader 804, in order to ensure that the requested type of data can be transmitted successfully to and received at the reader 804. At 814 (Step 4), in response to (e.g., based on) a successful completion of the random access procedure, the AIoT device 802 may transmit to the reader 804 a read end message including the requested type of data. At 816 (Step 5), the reader 804 may transmit to the core 806 the command response message that contains the data received from the AIoT device 802. The core 806 may forward the received data to the application client.

The procedures for inventory as described in FIG. 7 and the command in FIG. 8 are not mutual exclusive, and may be combined. For instance, the inventory and command procedure may be performed in sequence.

The following are techniques for selecting subsets (or subpopulations) of AIoT devices from a larger set (or population).

Numerous types of information are stored in the non-volatile memory of an AIoT device. These types can include identifiers, capabilities, random values, and so forth. Table 2 describes the types of information, associated parameters and their values of information or data stored in non-volatile memory of an AIoT device.

TABLE 2

| Type of | | | |
|---|---|---|---|
| information | Parameter | Value | Description |
| Device ID | >Unique device ID | X bits | Indicates the unique device ID |
| | | | (of length X bits) that is |
| | | | assigned to the device. The |
| | | | unique device ID may consist of |
| | | | a manufacturer ID and a serial |
| | | | number. The length X may be, |
| | | | for example, {40, 80, 160}. |
| | >EPC | Y bits | Indicates the EPC (of length Y |
| | | | bits) that is assigned to the |
| | | | object to which the device is |
| | | | attached. The length Y may be, |
| | | | for example, {96, 256}. |
| Device | >Device type | BITSTRING {3} | Indicates the device type. The |
| type | | | first bit refers to type 1, the |
| | | | second bit refers to type 2a and |
| | | | the third bit refers to type 2b. If |
| | | | a bit is set to “1” then the |
| | | | corresponding device type is |
| | | | supported. Otherwise, it is not |
| | | | supported. |
| Memory | >Maximum memory | {1 kByte, 2 | Indicates the maximum size of |
| storage | size NVM | kBytes, 4 kBytes, | NVM supported by the device. |
| capability | | 6 kBytes, | |
| | | 8 kBytes} | |
| | >Maximum memory | {1 kByte, 2 | Indicates the maximum size of |
| | size VM | kBytes, 4 kBytes, | VM supported by the device. |
| | | 6 kBytes, | |
| | | 8 kBytes} | |
| Security | >Security profile | BITSTRING {1, | Indicates the supported security |
| capabilities | | . . ., L} | profiles. The first bit refers to |
| | | | profile #0, the second bit refers |
| | | | to profile #1 and so on. Each |
| | | | security profile may indicate the |
| | | | supported security algorithm, |
| | | | length of security key, etc. If a |
| | | | bit is set to “1” then the |
| | | | corresponding security profile is |
| | | | supported. Otherwise, it is not |
| | | | supported. Value L may be set |
| | | | to, for example, 4, 8 or 16. |
| Positioning | >Positioning profile | BITSTRING {1, | Indicates the supported |
| capabilities | | . . ., M} | positioning profiles. The first bit |
| | | | refers to profile #0, the second |
| | | | bit refers to profile #1 and so on. |
| | | | Each positioning profile may |
| | | | indicate the supported |
| | | | positioning mode, positioning |
| | | | method, modulation scheme of |
| | | | positioning pilot signal, etc. |
| | | | If a bit is set to “1” then the |
| | | | corresponding positioning |
| | | | profile is supported. Otherwise, |
| | | | it is not supported. Value M may |
| | | | be set to, for example, 4, 8 or 16. |
| Other | >Support of | {UL, DL, | Indicates whether data |
| capabilities | segmentation | UL + DL} | segmentation for UL, DL or |
| | | | UL + DL is supported by the |
| | | | device. |
| | >Support of buffer | {Yes, No} | Indicates whether buffer level |
| | level reporting | | reporting is supported by the |
| | | | device. |
| | >Support of energy | {Yes, No} | Indicates whether energy level |
| | level reporting | | reporting is supported by the |
| | | | device. |
| Network ID | >Network ID | MCC + MNC | Indicates the mobile country |
| | | | code (MCC) (3 digits) and |
| | | | mobile network code (MNC) (2 |
| | | | to 3 digits) of the home mobile |
| | | | operator of the device. |
| Manufacturer | >Manufacturer ID | Z bits | Indicates the manufacturer of the |
| ID | | | AIoT device. The length of the |
| | | | manufacturer ID may be Z bits. |
| | | | The length Z may be, for |
| | | | example, {8, 16}. |
| Service ID | >Service ID | BITSTRING {1, | Indicates the AIoT services the |
| | | . . ., N} | device is subscribed to. The first |
| | | | bit refers to service ID#0, the |
| | | | second bit refers to service ID#1 |
| | | | and so on. If a bit is set to “1” |
| | | | then the corresponding AIoT |
| | | | service is supported. Otherwise, |
| | | | it is not supported. Value N may |
| | | | be set to, for example, 4, 8 or 16. |
| Random | >Random value | A bits | Indicates a randomly selected |
| value | | | value by the AIoT device or by |
| | | | the home mobile operator of the |
| | | | AIOT device. It may be used as a |
| | | | temporary ID or for achieving |
| | | | further distribution of the AIoT |
| | | | devices to select, if desired. The |
| | | | length of the random value may |
| | | | be A bits. The value A may be |
| | | | set, for example, in the range 2 |
| | | | to 64. |
| | | | Additionally or alternatively, a |
| | | | hash value of length A bits using |
| | | | a hash function may be used |
| | | | instead. |

With respect to signaling and usage of selection criteria, based on the information stored in the non-volatile memory of each AIoT device as summarized in Table 2 and the request received from the application client, the network indicates to the reader the applicable criteria for selecting subsets of AIOT devices from a larger set. In detail, the messages with which the network starts the inventory procedure (e.g., Inventory Request message in FIG. 7) or command procedure (e.g., Command Request message in FIG. 8) contain the applicable selection criteria that the reader shall apply when transmitting the Inventory Start or Read, Write, Control, Enable, or Disable Start message to the target AIoT devices in the target area. The selection criteria are given by a list and have the same structure as the stored information in NVM.

Table 3 shows an example of setting selection criteria in the Inventory Request message with which the stored EPC from all device types (1, 2a, 2b) are to be retrieved.

TABLE 3

| Type of | | | |
|---|---|---|---|
| information | Parameter | Value | Description |
| Device ID | >Unique device ID | Not present | |
| | >EPC | Not present | |
| Device type | >Device type | BITSTRING | Indicates to retrieve the stored |
| | | {111} | EPC from all device types (1, 2a, |
| | | | 2b). |
| Memory storage | >Maximum memory | Not present | |
| capability | size NVM | | |
| | >Maximum memory | Not present | |
| | size VM | | |
| Security | >Security profile | Not present | |
| capabilities | | | |
| Positioning | >Positioning profile | Not present | |
| capabilities | | | |
| Other | >Support of | Not present | |
| capabilities | segmentation | | |
| | >Support of buffer | Not present | |
| | level reporting | | |
| | >Support of energy | Not present | |
| | level reporting | | |
| Network ID | >Network ID | Not present | |
| Manufacturer ID | >Manufacturer ID | Not present | |
| Service ID | >Service ID | Not present | |
| Random value | >Random value | Not present | |

Table 4 shows an example of setting selection criteria in the Command Request message (Read-command) with which the positioning capabilities shall be retrieved from all device types that are originated from the home mobile operator given by MCC-“262” and MNC=“024”, and subscribed to location services given by service ID #3.

TABLE 4

| Type of | | | |
|---|---|---|---|
| information | Parameter | Value | Description |
| Device ID | >Unique device ID | Not present | |
| | >EPC | Not present | |
| Device type | >Device type | BITSTRING | Indicates to retrieve data from |
| | | {111} | all device types (1, 2a, 2b). |
| Memory storage | >Maximum memory | Not present | |
| | size NVM | | |
| capability | >Maximum memory | Not present | |
| | size VM | | |
| Security | >Security profile | Not present | |
| capabilities | | | |
| Positioning | >Positioning | BITSTRING | Indicates to retrieve data from |
| capabilities | profile | {11111111} | the devices that support |
| | | | positioning. |
| Other | >Support of | Not present | |
| capabilities | segmentation | | |
| | >Support of buffer | Not present | |
| | level reporting | | |
| | >Support of energy | Not present | |
| | level reporting | | |
| Network ID | >Network ID | MCC (“262”) + | Indicates to retrieve data from |
| | | MNC (“024”) | the devices that are originated |
| | | | from the mobile operator given |
| | | | by MCC = “262” and MNC = |
| | | | “024”. |
| Manufacturer ID | >Manufacturer ID | Not present | |
| Service ID | >Service ID | BITSTRING | Indicates to retrieve data from |
| | | {0001} | the devices that are subscribed to |
| | | | location services given by |
| | | | service ID#3. |
| Random value | >Random value | Not present | |

In accordance with the applicable selection criteria received from the network the reader may perform the concerned procedures in several rounds in order to balance the load in the random access procedure that will take place between the target AIOT devices and the reader. For instance, if the concerned procedure (inventory or command) includes all device types, then the reader may perform the concerned procedure in three rounds: the first Inventory Start or Read Start message initiates the first round including the devices of type 1 only. After the successful completion of the first round, the second Inventory Start or Read Start message initiates the second round including the devices of type 2a only. And after the successful completion of the second round, the third Inventory Start or Read Start message initiates the third and last round including the devices of type 2b only.

The advantages of the techniques discussed herein include supporting a granular selection of subsets of AIoT devices from a larger set, and providing more flexibility in selecting subsets of AIoT devices from a larger set.

Following are some example implementations of the techniques discussed herein.

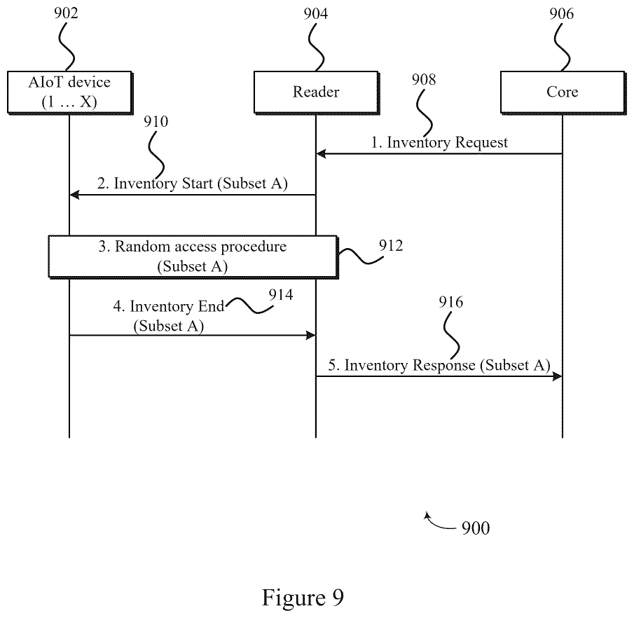

FIG. 9 illustrates an example signaling diagram 900 in accordance with aspects of the present disclosure. The signaling diagram 900 may include one or more AIoT devices 902, a reader 904, and a core 906 (e.g., a component of a CN 106 of FIG. 1, such as a 5GC). In the example of FIG. 9, the signaling diagram 900 may be associated with deployment scenario 1 with Topology 1 in which the reader 904 (e.g., a base station) is connected to a core (e.g., a component of the CN 106 of FIG. 1, such as a 5GC). By way of example, four pallets have been delivered to a warehouse and each pallet carries 100 products (e.g., goods, items, objects). AIoT devices of all device types have been attached to the products by the supplier. Each AIoT device 902 has stored information in its NVM according to Table 2 as described above. These products have not been previously inventoried, accordingly, it is unknown what kind of information is stored in the NVM of each AIoT device associated with each product. An application client of a management application platform of the warehouse is attached to the core 906 (e.g., 5GC) and transmits a request to the core 906 to retrieve EPC of each of the goods.

At 908 (Step 1), in response to (e.g., based on) the request received from the application client, the core 906 (e.g., an AMF or an AIoT function) may transmit an inventory request message to the reader 904 that serves the target area. The inventory request message may include a criteria (also referred to as selection criteria) for inventory-taking of the one or more AIoT devices 902 according to Table 3 discussed above. Accordingly, stored EPC from all device types (1, 2a, 2b) is to be retrieved by the reader 904.

At 910 (Step 2), in order to balance a load of a random access procedure, the reader 904 may determine to perform the inventory procedure iteratively (e.g., in three rounds). The reader 904 may transmit a first inventory start message to initiate a first round including devices of type 1 only, denoted as Subset A. In order to retrieve the stored EPC from the one or more AIoT devices 902 of Subset A, the first inventory start message may include the information “type 1” as the criteria.

At 912 (Step 3), in response to receiving (e.g., based on) the first inventory start message, the one or more AIoT devices 902 of Subset A (device #1 to device #X) may perform the random access procedure with the reader 904 in order to ensure that their stored EPC can be communicated (e.g. transmitted, received) successfully to the reader 904. At 914 (Step 4), in response to a successful completion of the random access procedure, each of the one or more AIoT devices 902 of Subset A may transmit to the reader 904 an inventory end message with a corresponding EPC stored at the corresponding AIoT device. At 916 (Step 5), the reader 904 may transmit to the core 906 an inventory response message that contains all the EPCs received from the one or more AIoT devices 902 of Subset A. The 5GC may forward the received EPCs to the application client.

After the successful completion of the first round, the reader 904 may transmit a second inventory start message to initiate the second round including the devices of type 2a only, denoted as Subset B. In order to retrieve the stored EPC from one or more AIoT devices 902 of Subset B (device #1 to device #Y), the second inventory start message may include the information “type 2a” as the criteria. For this second round, the same steps as in step 2 to step 5 are performed.

After the successful completion of the second round, the reader 904 may transmit a third inventory start message to initiate the third and last round including the devices of type 2b only, denoted as Subset C. In order to retrieve the stored EPC from one or more AIoT devices 902 of Subset C (device #1 to device #Z), the third inventory start message may include the information “type 2b” as the criteria. For this third round the same steps as in step 2 to step 5 are performed.

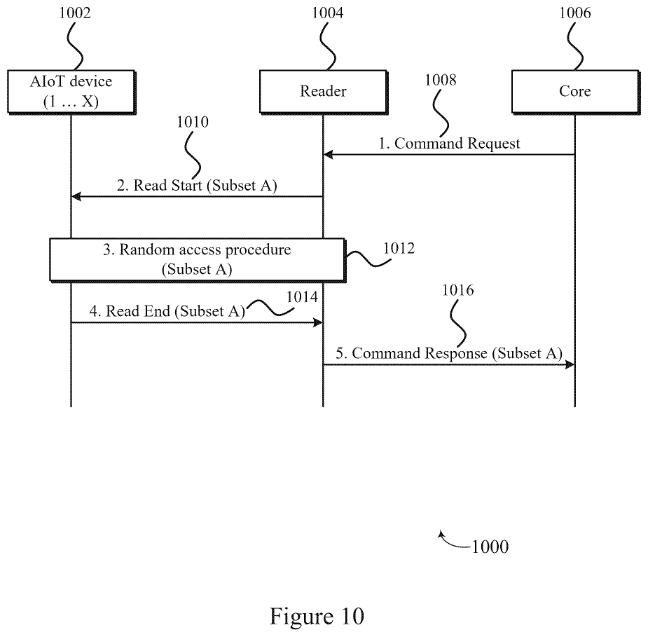

FIG. 10 illustrates an example signaling diagram 1000 in accordance with aspects of the present disclosure. The signaling diagram 1000 may include one or more AIoT devices 1002, a reader 1004, and a core 1006 (e.g., a component of a CN 106 of FIG. 1, such as a 5GC). In the example of FIG. 10, the signaling diagram 1000 may be associated with deployment scenario 1 with Topology 1 in which the reader 1004 (e.g., a base station) is connected to a core (e.g., a component of the CN 106 of FIG. 1, such as a 5GC). By way of example, four pallets are stored in a warehouse and each pallet carries 100 products (e.g., goods, items, objects). AIoT devices of all device types have been attached to the products by the supplier. Each AIoT device 1002 has stored information in its NVM according to Table 2 as described above. These products have been inventoried, accordingly, the warehouse management platform knows the EPC of each product to which an AIoT device is attached. The warehouse management platform wants to retrieve the positioning capabilities from all device types that are originated from the home mobile operator given by MCC= “262” and MNC= “024”, and subscribed to location services given by service ID #3. The application client of the warehouse management platform, which may be is attached to the core (e.g., 5GC), may transmit a corresponding request to the core 1006.

At 1008 (Step 1), in response to (e.g., based on) the request received from the application client, the core 1006 (e.g., an AMF or an AIoT function) may transmit a command request message to the reader 1004 that serves the target area. The command request message may include a read-command and a criteria (also referred to as selection criteria) according to Table 4 discussed above. Accordingly, positioning capabilities are to be retrieved from all device types that are originated from the home mobile operator given by MCC= “262” and MNC= “024”, and subscribed to location services given by service ID #3.

At 1010 (Step 2), in order to balance a load of a random access procedure, the reader 1004 may determine to perform the command procedure iteratively (e.g., in three rounds). The reader 1004 may transmit a first read start message to initiate a first round including devices of type 1 only, denoted as Subset A. In order to retrieve the stored positioning capabilities from the one or more AIoT devices 1002 of Subset A, the first read start message may include the information “type 1” as the criteria.

At 1012 (Step 3), in response to receiving (e.g., based on) the first read start message, the one or more AIoT devices 1002 of Subset A (device #1 to device #X) may perform the random access procedure with the reader 1004 in order to ensure that their stored positioning capabilities can be communicated (e.g., transmitted, received) successfully to the reader 1004. At 1014 (Step 4), in response to successful completion of the random access procedure, each of the one or more AIoT devices 1002 of Subset A may transmit to the reader 1004 a read end message with corresponding positioning capabilities stored at the corresponding AIoT device. At 1016 (Step 5), the reader 1004 may transmit to the core 1006 a command response message that contains all the positioning capabilities received from the one or more AIoT devices 1002 of Subset A. The core 1006 may then forward the received positioning capabilities to the application client.

After the successful completion of the first round, the reader 1004 may transmit a second read start message to initiate the second round including the devices of type 2a only, denoted as Subset B. In order to retrieve the stored positioning capabilities from one or more AIoT devices 902 of Subset B (device #1 to device #Y), the second read start message may include the information “type 2a” as the criteria. For this second round, the same steps as in step 2 to step 5 are performed.

After the successful completion of the second round, the reader 1004 may transmit a third read start message to initiate the third and last round including the devices of type 2b only, denoted as Subset C. In order to retrieve the stored positioning capabilities from one or more AIoT devices 902 of Subset C (device #1 to device #Z), the third read start message may include the information “type 2b” as the criteria. For this third round the same steps as in step 2 to step 5 are performed.

Accordingly, techniques for selecting subsets of AIoT devices from a larger set are discussed herein.

Storing numerous types of information in the non-volatile memory of an AIoT device is discussed herein. The information includes one or more of the Device ID, Device type, Memory storage capability, at least one Security capability, at least one Positioning capability, Other capabilities, a Network ID of a network operator of the AIoT device (e.g., the home mobile operator of the AIoT device), Manufacturer ID, Service ID of the AIoT services the AIoT device is subscribed to, or Random value.

With respect to signaling and usage of selection criteria, based on the information stored in the non-volatile memory of an AIoT device and the request received from the application client, the network indicates to the reader the applicable criteria for selecting subsets of AIoT devices from a larger set is discussed herein. The selection criteria are given by a list and have the same structure as the information stored in the non-volatile memory of an AIoT device is also discussed herein. In accordance with the applicable selection criteria received from the network the reader may perform the procedures for inventory and command in several rounds in order to balance the load in the random access procedure that will take place between the target AIoT devices and the reader is also discussed herein.

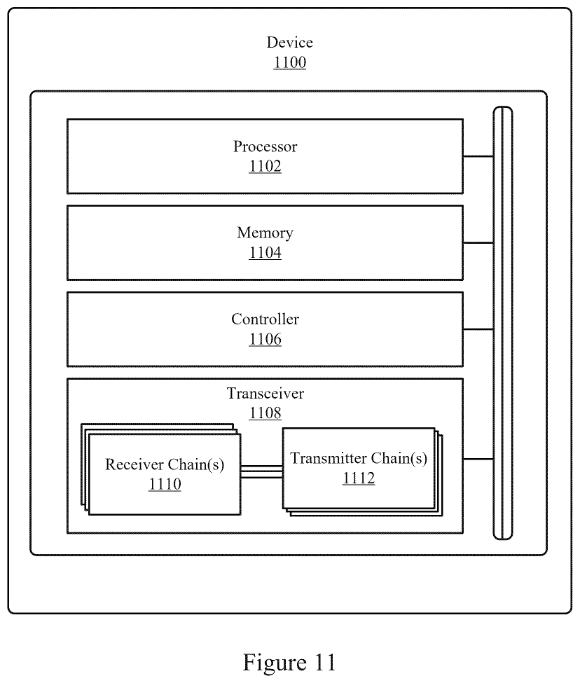

FIG. 11 illustrates an example of a device 1100 in accordance with aspects of the present disclosure. The device 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces. The device 1100 may be a low-power device (e.g., an AIoT device), a UE, an intermediate node, and so forth.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the device 1100 to perform various functions of the present disclosure.

The memory 1104 may include volatile or non-volatile memory. The memory 1104 may store computer-readable, computer-executable code including instructions when executed by the processor 1102 cause the device 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the device 1100 to perform one or more of the functions described herein (e.g., executing, by the processor 1102, instructions stored in the memory 1104). For example, the processor 1102 may support wireless communication at the device 1100 in accordance with examples as disclosed herein. The device 1100 (e.g., a first wireless device) may be configured to or operable to support a means for receiving a first message that indicates to initiate a procedure for a set of second wireless devices, where the first message includes a set of one or more of multiple types of information associated with the set of second wireless devices; transmitting a second message that indicates to initiate the procedure for a subset of second wireless devices based at least in part on the set of one or more of multiple types of information, where the subset of second wireless devices is a subset of the set of second wireless devices; and receiving a third message from at least one second wireless device of the subset of second wireless devices in response to the second message.

Additionally, the device 1100 may be configured to support any one or combination of where receiving the first message comprises receiving the first message from a network entity associated with a core network; where for each wireless device of the set of second wireless devices, the set of one or more of multiple types of information include one or more of a device identifier (ID) of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value; where the procedure comprises an inventory or command procedure; where each wireless device of the set of second wireless devices comprises a low-complexity and low-power device; where the first wireless device comprises a network node or an intermediate node.

Additionally, or alternatively, the device 1100 (e.g., a first wireless device) may support at least one memory (e.g., the memory 1104) and at least one processor (e.g., the processor 1102) coupled with the at least one memory and configured to cause the device to: receive a first message that indicates to initiate a procedure for a set of second wireless devices, where the first message includes a set of one or more of multiple types of information associated with the set of second wireless devices; transmit a second message that indicates to initiate the procedure for a subset of second wireless devices based at least in part on the set of one or more of multiple types of information, where the subset of second wireless devices is a subset of the set of second wireless devices; receive a third message from at least one second wireless device of the subset of second wireless devices in response to the second message.

Additionally, the device 1100 may be configured to support any one or combination of the at least one processor is configured to cause the first wireless device to receive the first message from a network entity associated with a core network; where for each wireless device of the set of second wireless devices, the set of one or more of multiple types of information include one or more of a device identifier (ID) of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value; where the procedure comprises an inventory or command procedure; where each wireless device of the set of second wireless devices comprises a low-complexity and low-power device; where the first wireless device comprises a network node or an intermediate node.

In some implementations, the processor 1102 and the memory 1104 coupled with the processor 1102 may be configured to cause the device 1100 to perform one or more of the functions described herein (e.g., executing, by the processor 1102, instructions stored in the memory 1104). For example, the processor 1102 may support wireless communication at the device 1100 in accordance with examples as disclosed herein. The device 1100 (e.g., a first wireless device) may be configured to or operable to support a means for receiving a first message that indicates to initiate a procedure for a subset of wireless devices based at least in part on a set of one or more of multiple types of information stored in a set of wireless devices, where the subset of wireless devices is a subset of the set of wireless devices, and where the first wireless device is part of the set of wireless devices; and transmitting a second message, in response to the first message, if the first wireless device satisfies the set of one or more of multiple types of information.

Additionally, the device 1100 may be configured to support any one or combination of where the set of one or more of multiple types of information stored in the first wireless device include one or more of a device identifier (ID) of the first wireless device, a device type of the first wireless device, a memory storage capability of the first wireless device, a security capability of the first wireless device, a positioning capability of the first wireless device, a network ID of a network operator of the first wireless device, a manufacturer ID of the first wireless device, a service ID of one or more services the first wireless device is subscribed to, or a random value; where the set of one or more of multiple types of information are stored in non-volatile memory of the first wireless device; where the procedure comprises an inventory or command procedure; where the first wireless devices comprises a low-complexity and low-power device.

Additionally, or alternatively, the device 1100 (e.g., a first wireless device) may support at least one memory (e.g., the memory 1104) and at least one processor (e.g., the processor 1102) coupled with the at least one memory and configured to cause the device to: receive a first message that indicates to initiate a procedure for a subset of wireless devices based at least in part on a set of one or more of multiple types of information stored in a set of wireless devices, where the subset of wireless devices is a subset of the set of wireless devices, and where the first wireless device is part of the set of wireless devices; transmit a second message, in response to the first message, if the first wireless device satisfies the set of one or more of multiple types of information.

Additionally, the device 1100 may be configured to support any one or combination of the at least one processor is configured to where the set of one or more of multiple types of information stored in the first wireless device include one or more of a device identifier (ID) of the first wireless device, a device type of the first wireless device, a memory storage capability of the first wireless device, a security capability of the first wireless device, a positioning capability of the first wireless device, a network ID of a network operator of the first wireless device, a manufacturer ID of the first wireless device, a service ID of one or more services the first wireless device is subscribed to, or a random value; where the set of one or more of multiple types of information are stored in non-volatile memory of the first wireless device; where the procedure comprises an inventory or command procedure; where the first wireless devices comprises a low-complexity and low-power device.

The controller 1106 may manage input and output signals for the device 1100. The controller 1106 may also manage peripherals not integrated into the device 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the device 1100 may include at least one transceiver 1108. In some other implementations, the device 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

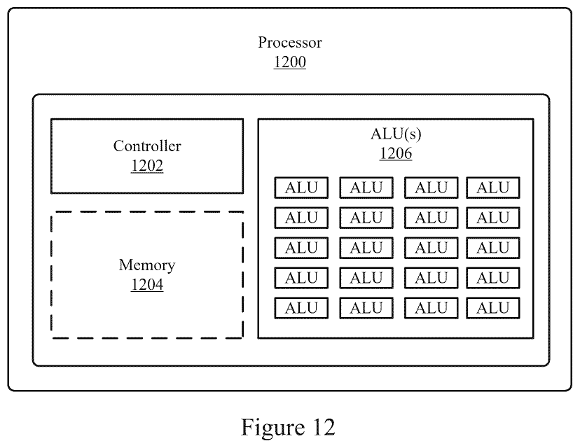

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory addresses of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, ALUs 1206, and other functional units of the processor 1200.

The memory 1204 may include one or more caches (e.g., memory local to or included in the processor 1200 or other memory, such as RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, and the controller 1202, and may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 may be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support at least one controller (e.g., the controller 1202) coupled with at least one memory (e.g., the memory 1204) and configured to cause the processor to: receive a first message that indicates to initiate a procedure for a set of second wireless devices, where the first message includes a set of one or more of multiple types of information associated with the set of second wireless devices; transmit a second message that indicates to initiate the procedure for a subset of second wireless devices based at least in part on the set of one or more of multiple types of information, where the subset of second wireless devices is a subset of the set of second wireless devices; receive a third message from at least one wireless device of the subset of second wireless devices in response to the second message.

Additionally, the processor 1200 may be configured to or operable to support any one or combination of the at least one controller is configured to cause the processor to receive the first message from a network entity associated with a core network; where for each wireless device of the set of second wireless devices, the set of one or more of multiple types of information include one or more of a device identifier (ID) of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value; where the procedure comprises an inventory or command procedure; where each wireless device of the set of second wireless devices comprises a low-complexity and low-power device; where the processor is included in a network node or an intermediate node.

The processor 1200 may support wireless communication in accordance with examples as disclosed herein. The processor 1200 (e.g., of a first wireless device) may be configured to or operable to support at least one controller (e.g., the controller 1202) coupled with at least one memory (e.g., the memory 1204) and configured to cause the processor to: receive a first message that indicates to initiate a procedure for a subset of wireless devices based at least in part on a set of one or more of multiple types of information stored in a set of wireless devices, where the subset of wireless devices is a subset of the set of wireless devices, and where the first wireless device is part of the set of wireless devices; transmit a second message, in response to the first message, if the first wireless device satisfies the set of one or more of multiple types of information.

Additionally, the processor 1200 may be configured to or operable to support any one or combination of the at least one controller is configured to cause the processor to where the set of one or more of multiple types of information stored in the first wireless device include one or more of a device identifier (ID) of the first wireless device, a device type of the first wireless device, a memory storage capability of the first wireless device, a security capability of the first wireless device, a positioning capability of the first wireless device, a network ID of a network operator of the first wireless device, a manufacturer ID of the first wireless device, a service ID of one or more services the first wireless device is subscribed to, or a random value; where the set of one or more of multiple types of information are stored in non-volatile memory of the first wireless device; where the procedure comprises an inventory or command procedure; where the first wireless devices comprises a low-complexity and low-power device.

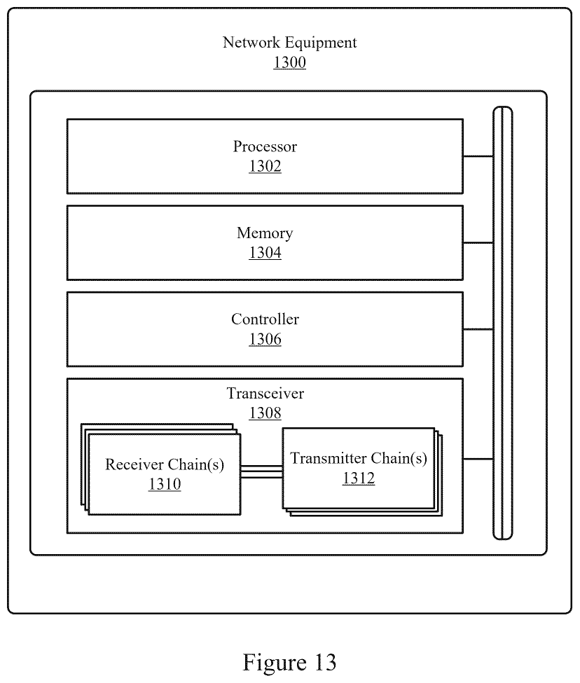

FIG. 13 illustrates an example of an NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 (e.g., a first wireless device) may be configured to support a means for receiving a first message that indicates to initiate a procedure for a set of second wireless devices, where the first message includes a set of one or more of multiple types of information associated with the set of second wireless devices; transmitting a second message that indicates to initiate the procedure for a subset of second wireless devices based at least in part on the set of one or more of multiple types of information, where the subset of second wireless devices is a subset of the set of second wireless devices; and receiving a third message from at least one second wireless device of the subset of second wireless devices in response to the second message.

Additionally, the NE 1300 may be configured to support any one or combination of where receiving the first message comprises receiving the first message from a network entity associated with a core network; where for each wireless device of the set of second wireless devices, the set of one or more of multiple types of information include one or more of a device identifier (ID) of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value; where the procedure comprises an inventory or command procedure; where each wireless device of the set of second wireless devices comprises a low-complexity and low-power device; where the first wireless device comprises a network node or an intermediate node.

Additionally, or alternatively, the NE 1300 may support at least one memory (e.g., the memory 1304) and at least one processor (e.g., the processor 1302) coupled with the at least one memory and configured to cause the NE (e.g., a first wireless device) to: receive a first message that indicates to initiate a procedure for a set of second wireless devices, where the first message includes a set of one or more of multiple types of information associated with the set of second wireless devices; transmit a second message that indicates to initiate the procedure for a subset of second wireless devices based at least in part on the set of one or more of multiple types of information, where the subset of second wireless devices is a subset of the set of second wireless devices; receive a third message from at least one second wireless device of the subset of second wireless devices in response to the second message.

Additionally, the NE 1300 may be configured to support any one or combination of the at least one processor is configured to cause the first wireless device to receive the first message from a network entity associated with a core network; where for each wireless device of the set of second wireless devices, the set of one or more of multiple types of information include one or more of a device identifier (ID) of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value; where the procedure comprises an inventory or command procedure; where each wireless device of the set of second wireless devices comprises a low-complexity and low-power device; where the first wireless device comprises a network node or an intermediate node.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

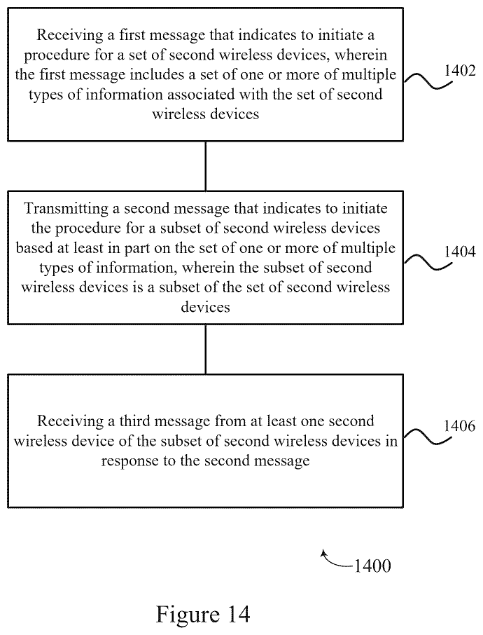

FIG. 14 illustrates a flowchart of a method 1400 in accordance with aspects of the present disclosure. The operations of the method may be implemented by a device as described herein, such as a device (e.g., a UE) or an NE. In some implementations, the device may execute a set of instructions to control the function elements of the device to perform the described functions. In some implementations, the NE may execute a set of instructions to control the function elements of the NE to perform the described functions.

At 1402, the method may include receiving a first message that indicates to initiate a procedure for a set of second wireless devices, wherein the first message includes a set of one or more of multiple types of information associated with the set of second wireless devices. The operations of 1402 may be performed in accordance with examples as described herein. In some implementations, aspects of the operations of 1402 may be performed by a device as described with reference to FIG. 11. Additionally or alternatively, aspects of the operations of 1402 may be performed by an NE as described with reference to FIG. 13.

At 1404, the method may include transmitting a second message that indicates to initiate the procedure for a subset of second wireless devices based at least in part on the set of one or more of multiple types of information, wherein the subset of second wireless devices is a subset of the set of second wireless devices. The operations of 1404 may be performed in accordance with examples as described herein. In some implementations, aspects of the operations of 1404 may be performed by a device as described with reference to FIG. 11. Additionally or alternatively, aspects of the operations of 1404 may be performed by an NE as described with reference to FIG. 13.

At 1406, the method may include receiving a third message from at least one second wireless device of the subset of second wireless devices in response to the second message. The operations of 1406 may be performed in accordance with examples as described herein. In some implementations, aspects of the operations of 1406 may be performed by a device as described with reference to FIG. 11. Additionally or alternatively, aspects of the operations of 1406 may be performed by an NE as described with reference to FIG. 13.

It should be noted that the method described herein describes a possible implementation, and that the operations and the steps may be rearranged or otherwise modified and that other implementations are possible.

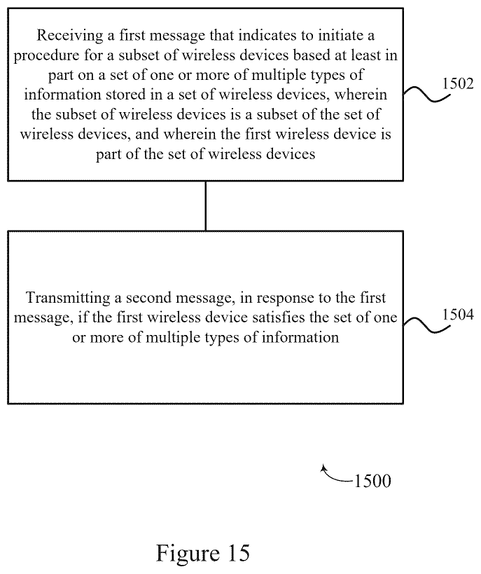

FIG. 15 illustrates a flowchart of a method 1500 in accordance with aspects of the present disclosure. The operations of the method may be implemented by a device as described herein, such as an AIoT device, or a low-power device. In some implementations, the AIoT device or low-power device may execute a set of instructions to control the function elements of the AIoT device or low-power device to perform the described functions.

At 1502, the method may include receiving a first message that indicates to initiate a procedure for a subset of wireless devices based at least in part on at least one selection criteria, wherein the at least one selection criteria identifies at least one of multiple types of information stored in a set of wireless devices, wherein the subset of wireless devices is a subset of the set of wireless devices, and wherein the first wireless device is part of the set of wireless devices. The operations of 1502 may be performed in accordance with examples as described herein. In some implementations, aspects of the operations of 1502 may be performed by a device as described with reference to FIG. 11.

At 1504, the method may include transmitting a second message, in response to the first message, if the first wireless device satisfies the at least one selection criteria. The operations of 1504 may be performed in accordance with examples as described herein. In some implementations, aspects of the operations of 1504 may be performed by a device as described with reference to FIG. 11.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device for wireless communication, comprising:
at least one memory; and
at least one processor coupled with the at least one memory and configured to cause the first wireless device to:
receive a first message that indicates to initiate a procedure for a set of second wireless devices, wherein the first message includes a set of one or more of multiple types of information associated with the set of second wireless devices;
transmit a second message that indicates to initiate the procedure for a subset of second wireless devices based at least in part on the set of one or more of multiple types of information, wherein the subset of second wireless devices is a subset of the set of second wireless devices;
receive a third message from at least one second wireless device of the subset of second wireless devices in response to the second message.

2. The first wireless device of claim 1, wherein the at least one processor is further configured to cause the first wireless device to receive the first message from a network entity associated with a core network.

3. The first wireless device of claim 1, wherein for each wireless device of the set of second wireless devices, the set of one or more of multiple types of information include one or more of a device identifier (ID) of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value.

4. The first wireless device of claim 1, wherein the procedure comprises an inventory or command procedure.

5. The first wireless device of claim 1, wherein each wireless device of the set of second wireless devices comprises a low-complexity and low-power device.

6. The first wireless device of claim 1, wherein the first wireless device comprises a network node or an intermediate node.

7. A processor for wireless communication, comprising:
at least one controller coupled with at least one memory and configured to cause the processor to:
receive a first message that indicates to initiate a procedure for a set of second wireless devices, wherein the first message includes a set of one or more of multiple types of information associated with the set of second wireless devices;
transmit a second message that indicates to initiate the procedure for a subset of second wireless devices based at least in part on the set of one or more of multiple types of information, wherein the subset of second wireless devices is a subset of the set of second wireless devices;
receive a third message from at least one wireless device of the subset of second wireless devices in response to the second message.

8. The processor of claim 7, wherein the at least one controller is further configured to cause the processor to receive the first message from a network entity associated with a core network.

9. The processor of claim 7, wherein for each wireless device of the set of second wireless devices, the set of one or more of multiple types of information include one or more of a device identifier (ID) of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value.

10. The processor of claim 7, wherein the procedure comprises an inventory or command procedure.

11. The processor of claim 7, wherein each wireless device of the set of second wireless devices comprises a low-complexity and low-power device.

12. The processor of claim 7, wherein the processor is included in a network node or an intermediate node.

13. A first wireless device for wireless communication, comprising:
at least one memory; and
at least one processor coupled with the at least one memory and configured to cause the first wireless device to:
receive a first message that indicates to initiate a procedure for a subset of wireless devices based at least in part on a set of one or more of multiple types of information stored in a set of wireless devices, wherein the subset of wireless devices is a subset of the set of wireless devices, and wherein the first wireless device is part of the set of wireless devices;
transmit a second message, in response to the first message, if the first wireless device satisfies the set of one or more of multiple types of information.

14. The first wireless device of claim 13, wherein the set of one or more of multiple types of information stored in the first wireless device include one or more of a device identifier (ID) of the first wireless device, a device type of the first wireless device, a memory storage capability of the first wireless device, a security capability of the first wireless device, a positioning capability of the first wireless device, a network ID of a network operator of the first wireless device, a manufacturer ID of the first wireless device, a service ID of one or more services the first wireless device is subscribed to, or a random value.

15. The first wireless device of claim 14, wherein the set of one or more of multiple types of information are stored in non-volatile memory of the first wireless device.

16. The first wireless device of claim 13, wherein the procedure comprises an inventory or command procedure.

17. The first wireless device of claim 13, wherein the first wireless devices comprises a low-complexity and low-power device.

18. A method performed by a first wireless device, the method comprising:
receiving a first message that indicates to initiate a procedure for a set of second wireless devices, wherein the first message includes a set of one or more of multiple types of information associated with the set of second wireless devices;
transmitting a second message that indicates to initiate the procedure for a subset of second wireless devices based at least in part on the set of one or more of multiple types of information, wherein the subset of second wireless devices is a subset of the set of second wireless devices; and
receiving a third message from at least one second wireless device of the subset of second wireless devices in response to the second message.

19. The method of claim 18, wherein receiving the first message comprises receiving the first message from a network entity associated with a core network.

20. The method of claim 18, wherein for each wireless device of the set of second wireless devices, the set of one or more of multiple types of information include one or more of a device identifier (ID) of the second wireless device, a device type of the second wireless device, a memory storage capability of the second wireless device, a security capability of the second wireless device, a positioning capability of the second wireless device, a network ID of a network operator of the second wireless device, a manufacturer ID of the second wireless device, a service ID of one or more services the second wireless device is subscribed to, or a random value.
